(19) United States
(12) Patent Application Publication
(10) Pub. No.: US 2001/0020242 A1
(43) Pub. Date: Sep. 6, 2001

(54) METHOD AND APPARATUS FOR PROCESSING CLIENT INFORMATION

(76) Inventors: AMIT GUPTA, FREMONT, CA (US); SRIRAMAN VENKATRAMAN, LONDON (GB); GEOFFREY BAEHR, MENLO PARK, CA (US)

Correspondence Address: THE HECKER LAW GROUP, 1925 CENTURY PARK EAST, SUITE 2300, LOS ANGELES, CA, 90067, US

(21) Appl. No.: 09/192,806

(22) Filed: Nov. 16, 1998

(51) Int. Cl. G06F 15/00

(52) U.S. Cl. 707/501.1

(57) ABSTRACT

A method and apparatus for processing user information. Information collection is increasingly utilized by advertisers and others that desire to customize a user's display for the user's individual preferences. According to one ore more embodiments of the invention, Internet Service Providers (ISPs) or proxies owned by an ISP collect and store information regarding particular users in a user profile. The information may include demographic information such as the user's age, residence, credit history, etc. Additionally, the information may include the web sites that the user has accessed, the time spent on each web site, and any internet searches performed by the user. The profile information may be utilized by the proxy to conduct targeted advertising, the information may be provided to a web host so that the web host may conduct targeted advertising, or the information may be utilized to customize a user's display, for example. The profile information may also be utilized to associate a cost with certain demographic information. For example, if the profile information indicates that the user is interested in automobiles, a premium may be charged to an automobile advertiser. The profile information may be evaluated by the ISP for advertisement insertion or customized displays. Alternatively, the profile information may be sold to a third party such as an advertiser. Thus, the profile and demographic information can be utilized to individually customize information displayed to a client.

### BACKGROUND OF THE INVENTION

1. Field of the Invention

This invention relates to the field of computer software, and, more specifically, to collecting, processing and utilizing a client's information on the internet.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever. Sun, Sun Microsystems, the Sun logo, Solaris, Java, JavaOS, JavaStation, HotJava Views and all Java-based trademarks and logos are trademarks or registered trademarks of Sun Microsystems, Inc. in the United States and other countries.

2. Background Art

In a computer network environment and the internet, client (user) information is a valuable asset for directed advertising and email solicitations, for example. Thus, it is desirable to collect various types of information about a client including their name, address, credit information, and information regarding the web sites that the user has accessed, for example. This information can then be utilized to customize the information that is displayed or transmitted to the user. Prior art information collection systems on the internet are incomplete and not utilized. These problems can be understood by reviewing networks, internets, and information collection and how they work.

Networks

In modern computing environments, it is commonplace to employ multiple computers or workstations linked together in a network to communicate between, and share data with, network users. A network also may include resources, such as printers, modems, file servers, etc., and may also include services, such as electronic mail.

A network can be a small system that is physically connected by cables (a local area network or “LAN”), or several separate networks can be connected together to form a larger network (a wide area network or “WAN”). Other types of networks include the internet, tel-com networks, the World Wide Web, intranets, extranets, wireless networks, and other networks over which electronic, digital, and/or analog data may be communicated.

Computer systems sometimes rely on a server computer system to provide information to requesting computers on a network. When there are a large number of requesting computers, it may be necessary to have more than one server computer system to handle the requests.

The Internet

The Internet is a worldwide network of interconnected computers. An Internet client accesses a computer on the network via an Internet provider. An Internet provider is an organization that provides a client (e.g., an individual or other organization) with access to the Internet (via analog telephone line or Integrated Services Digital Network line, for example). A client can, for example, read information from, download a file from or send an electronic mail message to another computer/client using the Internet.

To retrieve a file or service on the Internet, a client must search for the file or service, make a connection to the computer on which the file or service is stored, and download the file or service. Each of these steps may involve a separate application and access to multiple, dissimilar computer systems. The World Wide Web (WWW) was developed to provide a simpler, more uniform means for accessing information on the Internet.

The components of the WWW include browser software, network links, servers. and WWW protocols. The browser software, or browser, is a user-friendly interface (i.e., front-end) that simplifies access to the Internet. A browser allows a client to communicate a request without having to learn a complicated command syntax, for example. A browser typically provides a graphical user interface (GUI) for displaying information and receiving input. Examples of browsers currently available include Mosaic, Netscape Navigator and Communicator, Microsoft Internet Explorer, and Cello.

Information servers maintain the information on the WWW and are capable of processing a client request. Hypertext Transport Protocol (HTTP) is the standard protocol for communication with an information server on the WWW. HTTP has communication methods that allow clients to request data from a server and send information to the server.

To submit a request, the client contacts the HTTP server and transmits the request to the HTTP server. The request contains the communication method requested for the transaction (e.g., GET an object from the server or POST data to an object on the server). The HTTP server responds to the client by sending a status of the request and the requested information. The connection is then terminated between the client and the HTTP server.

A client request therefore, consists of establishing a connection between the client and the HTTP server, performing the request, and terminating the connection. The HTTP server does not retain any information about the request after the connection has been terminated. HTTP is, therefore, a stateless protocol. That is, a client can make several requests of an HTTP server, but each individual request is treated independent of any other request. The server has no recollection of any previous request.

Instead of transmitting the information from the server that maintains the information, some systems utilize what is referred to as a proxy. Referring to FIG. 1, a proxy 102 is a server that carries out requests transmitted to it (i.e., from client 100), keeping copies of fetched documents or information for some time so that they can be accessed more quickly in the future, speeding up access for commonly requested information. This maintaining of information and fetched documents by the proxy 102 is referred to as caching and the information maintained in the proxy 102 is referred to as a cache or proxy cache.

To protect information in internal computer networks from external access, a firewall is utilized. A firewall is a mechanism that blocks access between the client and the server. To provide limited access to information, a proxy or proxy server may sit atop a firewall and act as a conduit, providing a specific connection for each network connection. Proxy software retains the ability to communicate with external sources, yet is trusted to communicate with the internal network. For example, proxy software may require a username and password to access certain sections of the internal network and completely block other sections from any external access.

An addressing scheme is employed to identify Internet resources (e.g., HTTP server, file or program). This addressing scheme is called Uniform Resource Locator (URL). A URL contains the protocol to use when accessing the server (e.g., HTTP), the Internet domain name of the site on which the server is running, the port number of the server, and the location of the resource in the file structure of the server.

The WWW uses a concept known as hypertext. Hypertext provides the ability to create links within a document to move directly to other information. To activate the link, it is only necessary to click on the hypertext link (e.g., a word or phrase). The hypertext link can be to information stored on a different site than the one that supplied the current information. A URL is associated with the link to identify the location of the additional information. When the link is activated, the client's browser uses the link to access the data at the site specified in the URL.

If the client request is for a file, the HTTP server locates the file and sends it to the client. An HTTP server also has the ability to delegate work to gateway programs. The Common Gateway Interface (CGI) specification defines a mechanism by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard input, for example). The server forwards the data to the client using the HTTP.

A browser displays information to a client/user as pages or documents (referred to as “web pages” or “web sites”). A language is used to define the format for a page to be displayed in the WWW. The language is called Hypertext Markup Language (HTML). A WWW page is transmitted to a client as an HTML document. The browser executing at the client parses the document and displays a page based on the information in the HTML document.

HTML is a structural language that is comprised of HTML elements that are nested within each other. An HTML document is a text file in which certain strings of characters, called tags, mark regions of the document and assign special meaning to them. These regions are called HTML elements. Each element has a name, or tag. An element can have attributes that specify properties of the element. Blocks or components include unordered list, text boxes, check boxes, and radio buttons, for example. Each block has properties such as name, type, and value. The following provides an example of the structure of an HTML document:

<HTML>

<HEAD>
.... element(s) valid in the document head
</HEAD>
<BODY>
.... element(s) valid in the document body
</BODY>

</HTML>

Each HTML element is delimited by the pair of characters “<” and “>”. The name of the HTML element is contained within the delimiting characters. The combination of the name and delimiting characters is referred to as a marker, or tag. Each element is identified by its marker. In most cases, each element has a start and ending marker. The ending marker is identified by the inclusion of an another character, “/” that follows the “<” character.

HTML is a hierarchical language. With the exception of the HTML element, all other elements are contained within another element. The HTML element encompasses the entire document. It identifies the enclosed text as an HTML document. The HEAD element is contained within the HTML element and includes information about the HTML document. The BODY element is contained within the HTML. The BODY element contains all of the text and other information to be displayed. Other HTML elements are described in HTML reference manuals.

Prior Art Information Collection Schemes

The prior art provide has a limited capability to customize the information transmitted and displayed to a user. One scheme attempts to customize information based on demographics. For example, a web site that provides information about a specific city (e.g., San Francisco) may attempt to customize information by placing advertisements for businesses located in or near San Francisco.

Another scheme bases customization on input from the user. For example, if a search for baby books were made on a search engine such as Yahoo, the web host for Yahoo may customize the returned information by displaying advertisements relating to baby merchandise such as strollers and high chairs.

Another scheme accesses cookies stored on individual's browsers to determine the types of web sites that have been accessed. Cookies are small pieces of information that can later be read back from a browser. When a web site is accessed, a cookie is sent by the web site identifying itself to the web browser. Cookies are stored by the browser and may be read back by any server that desires to access the cookies at a later date. Based on the information retrieved from the cookies, customized information targeted to the specific user's interests (based on the web sites that user has accessed or retrieved a cookie from) is provided. Alternatively, the scheme may evaluate the HTTP referring page information. To prevent this information from being distributed or used in any manner, software is available that enables users to strip off cookies or HTTP referring page information. Further, the information collected only pertains to the small set of sites with which the web site has a business relationship, either directly or indirectly.

Another scheme attempts to guess the geographic location of a user based on the client's internet protocol (IP) address. When accessing the internet, individual clients are differentiated from each other by a unique number referred to as an IP address. In this scheme, a database is maintained by the web host that contains a mapping that provides a correspondence between each IP address to a modem phone number. The mappings are created by retrieving the modem phone numbers and the different IP addresses that the modem phone numbers correspond to from internet service providers (ISP) (ISPs are companies that provide internet access to users). By searching the database for the IP address, the web host can deduce which modem phone number the user called in from. Based on the modem phone number and area code, the web host can deduce where geographically the user is from or what telephone exchange the user is closest to. Consequently, customized information may be provided to the user based on the estimated geographic location of the user.

Each of the above schemes relies on information retrieved from the user (which may be modified by the user) or attempts to guess information about the user. Consequently, customization is not precise and lower premiums are paid for the collected information by advertisers, or other purchasers of statistical information.

### SUMMARY OF THE INVENTION

A method and apparatus for processing user information. Information collection is increasingly utilized by advertisers and others that desire to customize a user's display for the user's individual preferences.

According to one ore more embodiments of the invention, Internet Service Providers (ISPs) or proxies owned by an ISP collect and store information regarding particular users in a user profile. The information may include demographic information such as the user's age, residence, credit history, etc. Additionally, the information may include the web sites that the user has accessed, the time spent on each web site, and any internet searches performed by the user.

The profile information may be utilized by the proxy to conduct targeted advertising, the information may be provided to a web host so that the web host may conduct targeted advertising, or the information may be utilized to customize a user's display, for example. The profile information may also be utilized to associate a cost with certain demographic information. For example, if the profile information indicates that the user is interested in automobiles, a premium may be charged to an automobile advertiser. The profile information may be evaluated by the ISP for advertisement insertion or customized displays. Alternatively, the profile information may be sold to a third party such as an advertiser. Thus, the profile and demographic information can be utilized to individually customize information displayed to a client.

### BRIEF DESCRIPTION OF THE DRAWINGS

FIG. 1 illustrates a prior art method for processing web pages.

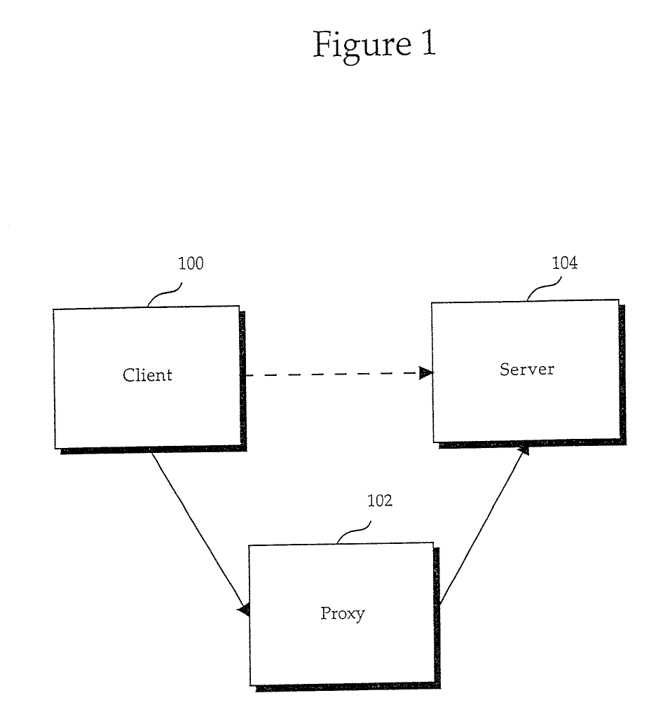

FIG. 2 is a block diagram of one embodiment of a computer system capable of providing a suitable execution environment for one or more embodiments of the invention.

FIG. 3 illustrates the relationship of an Online Profile Management System with a client, server, and proxy according to one or more embodiments of the invention.

FIG. 4 illustrates the relationship of a client, ISP, and web server with a roaming user according to one or more embodiments of the invention.

### DETAILED DESCRIPTION OF THE INVENTION

The invention is a method and apparatus for processing client information. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Embodiment of Computer Execution Environment (Hardware)

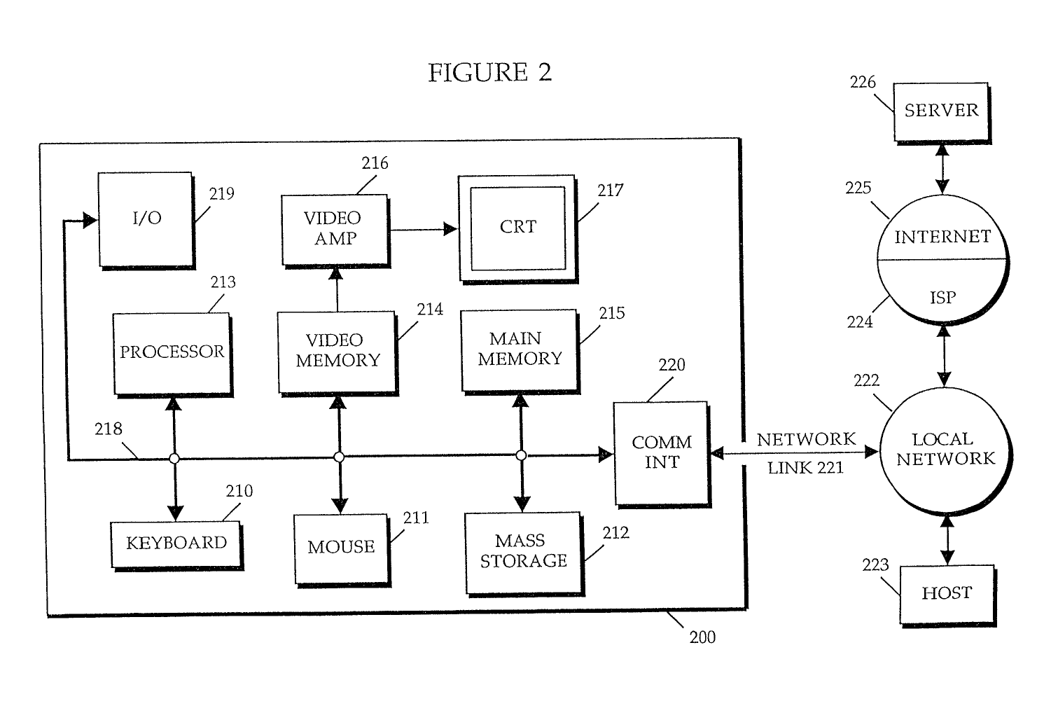

An embodiment of the invention can be implemented as computer software in the form of computer readable code executed on a general purpose computer such as computer 200 illustrated in FIG. 2, or in the form of bytecode class files running on such a computer. A keyboard 210 and mouse 211 are coupled to a bi-directional system bus 218. The keyboard and mouse are for introducing user input to the computer system and communicating that user input to processor 213. Other suitable input devices may be used in addition to, or in place of, the mouse 211 and keyboard 210. I/O (input/output) unit 219 coupled to bi-directional system bus 218 represents such I/O elements as a printer, A/V (audio/video) I/O, etc.

Computer 200 includes a video memory 214, main memory 215 and mass storage 212, all coupled to bi-directional system bus 218 along with keyboard 210, mouse 211 and processor 213. The mass storage 212 may include both fixed and removable media, such as magnetic, optical or magnetic optical storage systems or any other available mass storage technology. Bus 218 may contain, for example, thirty-two address lines for addressing video memory 214 or main memory 215. The system bus 218 also includes, for example, a 32-bit data bus for transferring data between and among the components, such as processor 213, main memory 215, video memory 214 and mass storage 212. Alternatively, multiplex data/address lines may be used instead of separate data and address lines.

In one embodiment of the invention, the processor 213 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 215 is comprised of dynamic random access memory (DRAM). Video memory 214 is a dual-ported video random access memory. One port of the video memory 214 is coupled to video amplifier 216. The video amplifier 216 is used to drive the cathode ray tube (CRT) raster monitor 217. Video amplifier 216 is well known in the art and may be implemented by any suitable apparatus. This circuitry converts pixel data stored in video memory 214 to a raster signal suitable for use by monitor 217. Monitor 217 is a type of monitor suitable for displaying graphic images.

Computer 200 may also include a communication interface 220 coupled to bus 218. Communication interface 220 provides a two-way data communication coupling via a network link 221 to a local network 222. For example, if communication interface 220 is an integrated services digital network (ISDN) card or a modem, communication interface 220 provides a data communication connection to the corresponding type of telephone line, which comprises part of network link 221. If communication interface 220 is a local area network (LAN) card, communication interface 220 provides a data communication connection via network link 221 to a compatible LAN. Wireless links are also possible. In any such implementation, communication interface 220 sends and receives electrical, electromagnetic or optical signals which carry digital data streams representing various types of information.

Network link 221 typically provides data communication through one or more networks to other data devices. For example, network link 221 may provide a connection through local network 222 to local server computer 223 or to data equipment operated by an Internet Service Provider (ISP) 224. ISP 224 in turn provides data communication services through the world wide packet data communication network now commonly referred to as the “Internet” 225. Local network 222 and Internet 225 both use electrical, electromagnetic or optical signals which carry digital data streams. The signals through the various networks and the signals on network link 221 and through communication interface 220, which carry the digital data to and from computer 200, are exemplary forms of carrier waves transporting the information.

Computer 200 can send messages and receive data, including program code, through the network(s), network link 221, and communication interface 220. In the Internet example, remote server computer 226 might transmit a requested code for an application program through Internet 225, ISP 224, local network 222 and communication interface 220.

The received code may be executed by processor 213 as it is received, and/or stored in mass storage 212, or other non-volatile storage for later execution. In this manner, computer 200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Embodiment of Software Apparatus for Processing Client Information

One or more embodiments of the invention provide for processing client information. Client information and the ability to utilize the information is a valuable asset for advertisers, direct marketers, and other interested parties. In the present information, user information is obtained by the ISP or intermediate proxy and utilized by the proxy or processed and sold to third parties.

Internet Service Providers (ISP)

For most users to access the internet, an ISP is utilized. To utilize an ISP, an off-line relationship between the user and the ISP is established wherein the user sets up an account with the ISP by supplying the user's name, address, and other relevant information (e.g., credit card number for payment, credit rating, etc.). In exchange, the ISP assigns a user name, password, and potentially a static IP address (or a dynamic IP address if dial in access is utilized) to the user. Additionally, the ISP may obtain information for other off-line sources.

Proxies (as described above) are usually owned and provided by a user's ISP. To access the internet, the user establishes a connection with the ISP or proxy. The user or client then requests a URL from a web server. The proxy intercepts the request, searches its cache for the requested information and returns the information to the client if the information is in the proxy's cache. If not in cache, the proxy communicates with the web server, retrieves the information, and forwards the information to the client.

Since the ISP or proxy is utilized to conduct all internet access, when a user views a web page or completes any transactions on the internet, each and every user action is processed through the ISP or a proxy of the ISP. Consequently, the ISP has the ability to maintain statistics on the user and the user's internet viewing (referred to as user information or profile information) transparently to the user (without the user's knowledge). More specifically, the ISP has the ability maintain a user's profile consisting of demographic information such as the user's age, credit history, earnings, interests, purchases, the sites (URLs) the user has accessed, the amount of time spent on each and every web site (URL), other user network accesses (such as emails, news readings/postings, etc.), and information when the user posts data or conducts searches (e.g., from queries/messages from a web server). Additionally, due to the off-line business relationship between the user and the ISP, privacy concerns may be addressed (compared to the lack of a business relationship with strangers).

Profile Collection

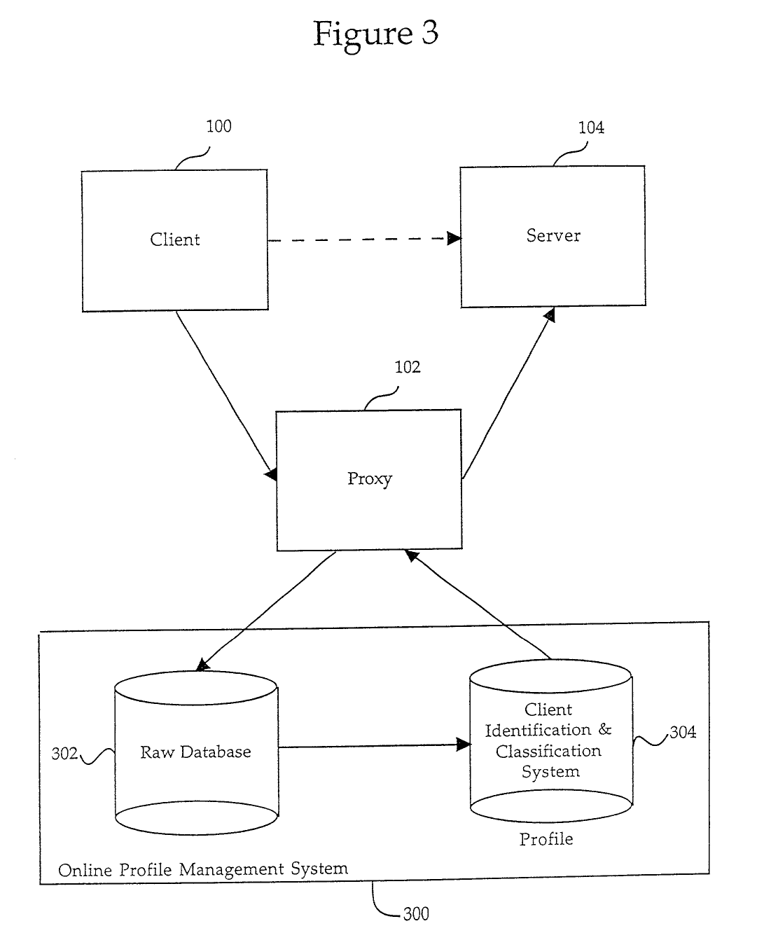

Profile information may be collected and maintained by a proxy in an Online Profile Management System. FIG. 3 demonstrates the relationship of an Online Profile Management System 300 with a client 100, server 104, and proxy 102. As described above, all URL requests, text, and other information is transmitted from client 100 to proxy 102. Proxy 102 copies this information and stores it locally in a raw database 302. Thus, each time client 100 initiates a request for a URL, information regarding the request is stored in raw database 302. Additionally, when a user executes a search on an internet search engine, the text of the search may be stored in raw database 302. One unique element that only the proxy or ISP has access to, is the time that a user spends on a particular web site. Such time spent information may also be stored in raw database 302. Additionally, the proxy may use the time spent information and other information to filter out search engine robots that repetitively access links of a web page to add to the search engine's database.

A profile 304 for each client is maintained in a Client Identification & Classification System. Profile 304 contains all information regarding a particular client or user including information collected off-line such as the user's name, residence, phone number, occupation, alternate email address, etc. The information from the raw database 302 is transferred and organized in the profile 304. Profile 304 may then be merged with other information databases such as mailing lists, direct marketing lists and subscriptions, a user's credit history, and shopping club information (e.g., if the user is a member of a market's shopping club, the information from the shopping club's database may be merged through an agreement between Proxy 102 and the market). The profile may also be time sensitive and created in real time so that when a user executes a search on an internet search engine, the search text is stored in the profile immediately. Additionally, if the user is at a non-payment based public terminal (e.g., at a library), the profile may be limited to the user's recent history and information about the terminal and terminal location may be utilized. Further, if the user is at a payment-based public terminal, the client's address, credit card information, and recent history as the user browses the internet may be utilized.

A profile is useful in determining the type of advertisement to display to a user. For example, if the profile indicates that client 100 executed a search for “flowers”, the advertiser may desire to transmit a local flower shop advertisement to client 100. A profile may also be utilized to specifically target clients that utilize a competitor's goods or services. For example, if the profile maintains knowledge that the client accesses a Pizza Hut web site, the ISP can include advertisements for Round Table Pizza or Dominos Pizza on the user's next web access, even if this access is to a totally unrelated site. Further, if the profile indicates that the client has inquired about Burger King Jack in the Box, fast food, hamburgers, etc., the ISP can include advertisements for McDonalds or another competitor.

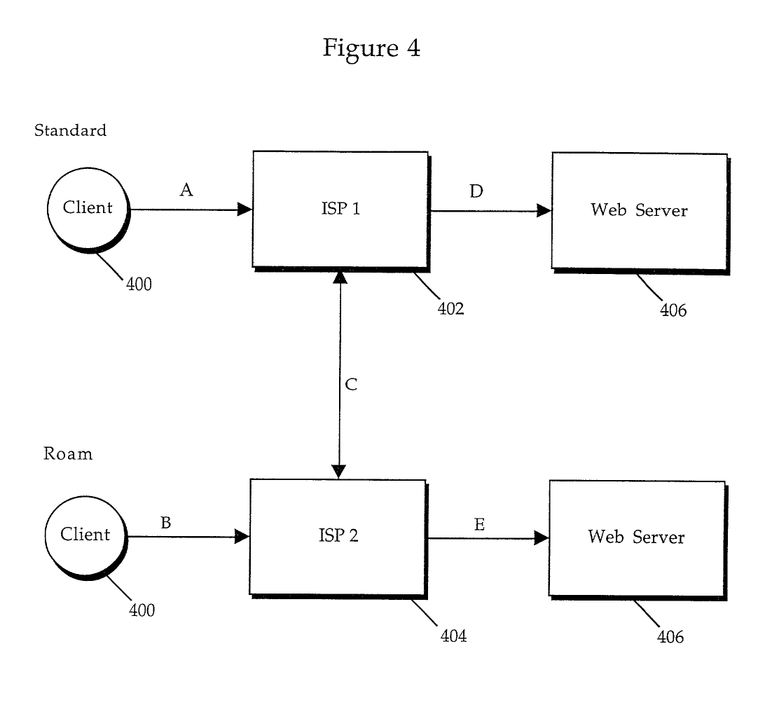

In addition to the above, a user or client 100 may roam into another ISP. This may occur when a user is traveling and dials into a phone number for a third party ISP or when the web browser utilizes the proxy of a third party ISP, for example. When client 100 roams into another ISP, the ISP may forward the request to the user's home ISP for local advertisement insertion (as described below), the ISP may obtain the profile information from the user's home ISP and use it for advertisement insertion, or the user's roaming profile can be returned to the home ISP. The above options and other options are demonstrated in FIG. 4, for example. If client 400 is roaming and utilizes ISP2 404, ISP2 404 may retrieve or purchase the user's profile from the user's standard ISP, ISP1 402. Under such an option, client 400 utilizes pathways B, C, and E to access web server 406. Alternatively, ISP2 may act as a path through for ISP1 with ISP1 providing the access to web server 406. Under this option, client 400 utilizes pathways B, C, and D to access web server 406 and ISP1 402 will perform any advertisement insertion. In another embodiment, ISP2 utilizes the current access profile of client 400 to place any advertisements. Under this embodiment, client 400 utilizes pathways B and E to access web server 406. In another embodiment, ISP2 404 negotiates with web server 406 for an advertisement insert and after concluding negotiations, offers ISP1 402 the option of inserting the advertisement for the same or an increased price. Under this option, client 400 utilizes pathways B, E, and C to access web server 406. In each of the above roaming user embodiments, ISP2 404 can return or sell the dynamically generated user profile (for that online session) to the user's standard ISP, ISP1 402.

Use of Profile Information

Once the user's profile information has been collected and stored as described above, the information may be utilized in various manners. For example, specific advertisements that target a user based on his preferences and profile may be inserted into a web page that is returned to the user. Advertisement insertion is more fully described in co-pending patent application Ser. No. ______ entitled “Method and Apparatus for Local Advertising on a Network” filed on ______, which is hereby incorporated by reference. Alternatively, the user's information be sold to a third party such as another ISP (with a roaming user), or to an advertising company. Additionally, a web page that is based on the user's preferences may be customized and displayed to the user. Further, an email advertisement or company offer may be forwarded to the proxy who can then determine which users to forward the email for a mass emailing. Additionally, the customized information may consist of inserting a watermark in the information transmitted to the client.

Advertisement Insertion

As described above, specific advertisements may be inserted based on the user's profile. After obtaining the profile information and a set of potential advertisements that may be inserted, the proxy must determine which particular advertisement to insert for this particular user. In one or more embodiments, a database that maps users to their profiles/preferences is utilized to access the profile information. In one or more embodiments, a database contains a mapping of profiles or preferences to a set of advertisements. In one or more embodiments, a database of advertisements with their prices is maintained.

Once desired databases and mappings are established, a policy for selecting the advertisement to insert may be utilized. For example, the proxy may implement a policy that displays the most expensive advertisements for a particular slot. In one or more embodiments, advertisements may be rotated for the same user so that the same user is not always displayed the same advertisement. In one or more embodiments, the advertisement may be selected based on the number of advertisements placed by an advertiser. For example, if Toyota has authorized 100 advertisement inserts and Nissan has authorized 100,000 advertisement inserts, the Nissan advertisements may be utilized more frequently to save the Toyota advertisements for when the Nissan advertisements cannot be used (based on the user's profile or other characteristic (e.g., limited browser capability)).

By evaluating demographic and profile information as described, direct marketing advertisers and one-on-one advertisers may more accurately target specific individuals. Further, the ISP (and other proxies) benefits (by selling advertising space and utilizing its collected profile and other information), the web server benefits (by selling more advertising space regardless of whether web server is small or large), the advertiser benefits by accurate targeting (resulting in an increased probability of a click-through), and client 100 benefits by receiving advertisements that the client may be particularly interested in. Additionally, if a client does not want its information released or collected, client may enter into a contract with ISP restricting the use, distribution, or collection of such information or utilize an ISP that does not maintain demographic databases or user profiles.

In one or more alternative embodiments, the proxy and server utilize a common user identification system to set advertisement selection and prices. For example, the server could identify a set of cookies or profile details for which it is willing to pay a specific price (e.g., 5 cents per display for a medium size slot). As a result, whenever the proxy intercepts a request from a user that matches the cookie or profile details, the proxy can elect whether or not to insert the advertisement for the server's set price.

Advertisement Tags

To specify advertisement characteristics, advertisement tag(s) may be specified in the HTML. The server could specify a tag or tag combination (e.g., a <A> . . . </A> block that follows one of the tags described below. Alternatively, the proxy could make an educated guess regarding the statistics using a new tag or based on a <A> . . . <IMG . . . ></A> tag combination (along with a database of substrings to match) for example. Different characteristics may be specified as part of one tag or multiple tags.

An ADRESTRICT tag may specify the categories/types of advertisements to allow/deny. For example, a religious web site may desire to exclude any advertisements for pornographic web sites or to only allow advertisements for books.

An ADDEMOGRAPHIC tag may specify demographic information about the user that the advertisement will be presented to. For example, the age, credit history, salary, interests, prior purchases, prior web sites accessed, web search conducted, shopping information, or time spent on a particular web site (which is only known by the ISP or proxy) may be specified. Alternatively, the ADDEMOGRAPHIC tag may be used in conjunction with the ADPRICE tag by the advertiser to inform the proxy what the advertiser is willing to pay for a specific advertisement displayed to a particular user with specified demographic information. For example, the advertiser may specify that he/she will pay 10 cents for a mortgage advertisement displayed to a first time home buyer and 5 cents for a mortgage advertisement displayed to an existing home owner.

Alternatively, instead of specifying the above information in the form of an HTML tag, the information may be specified as part of the URL request that is provided to the advertiser or as part of the data stream. For example, the server may specify that the advertisement slot in the HTML is transmitted as characters or bytes 55 to 75 of the data stream.

Web Page Customization

In one or more embodiments, the profile and collected information may be utilized to customize a web page displayed to a user. For example, if the user has expressed an interest in sports, news, and travel, a web page that contains that information may be created dynamically and displayed to the user. For example, the Yahoo search engine may display sports, news, and travel related pages to one user and beauty, nutrition, and travel related pages to another user. Further, if the user indicates his preferences to a search engine, every time other customizable pages are forwarded to the user, the user may not need to input the information.

Instead of the web server dynamically creating the web pages, the proxy can create and transmit them to the user. For example, Yahoo may transmit multiple types of pages to the proxy (e.g., sports, news, beauty, travel, electronic, etc.) which can be stored in the proxy's cache. When the proxy has been informed or determines that the user is interested in a particular field, the proxy can utilize the information stored in its cache to create a web page and transmit it to the user with a custom web page based on the user's preferences or interests. Such web page creation and transmission by the proxy is more efficient than a web server creating the web pages and decreases the transmission time needed to transmit the page to the client.

Email Based on User Information

The proxy may also forward emails with travel or sports event specials to the user based on the client/users' preferences. For example, the proxy may enter a contract with an advertiser or may promote specific types of events, products, or services, based on the user's profile. Further, a person or entity that desires to send mass email (for direct marketing, for example), can transmit the email to the proxy and let the proxy determine which specific users should receive the email. In this manner, email and email solicitations can be accurately targeted to specific individuals that may have a specific interest in the item that is being advertised.

For example, a mass email company may send an email to the proxy and inform the proxy that it is an advertisement for flowers. Instead of transmitting the email to every person, the proxy can elect specific persons that may have recently purchased flowers or would be interested in flowers (based on the user's profile). The proxy can also charge money based on the probability that the user would purchase flowers from the mass email company (or its client). Alternatively, the mass email company can specify a profile that the email should be sent to with the amount of money paid to the proxy based on the percentage of profile matches that the proxy has. Various price negotiation schemes for email may be utilized such as the price negotiation schemes for advertising that are more fully described in co-pending patent application Ser. No. ______ entitled “Method and Apparatus for Local Advertising” filed on ______.

Sale of Profile Information

As described above, the profile information may be sold to various entities. For example, an advertiser or mass email company may be interested in purchasing the information. Alternatively, in the case of a roaming user, the roaming ISP can sell the dynamically created profile to the user's standard ISP or the standard ISP can sell the user's profile to the roaming ISP.

User Identification

A client may be uniquely identified from other clients at any one point in time using various methods. For example, the IP address or port number may be a unique number assigned to client 100. However, since multiple family members may use the same computer with the same IP address or port number, a user's login name, or the user's login name concatenated with the IP address or port number may be utilized to unique identify a client from other clients and to differentiate between family members (the assigned IP address may also be mapped to a unique user identifier). The user can also be identified by the cookies that the user transmits to web sites. Alternatively, a group of users may be identifiable. For example, the ISP may assign a block of users to use the same proxy which may then be utilized to identify the aggregate of users. Consequently, based on the information, the advertiser may restrict the proxy to only insert advertisements on pages from chosen web sites, if desired.

Verification may be needed to determine if the demographics supplied by the ISP are accurate. Such verification is particularly useful when the cost of the information advertisement is dependent on the demographics (e.g., a Mercedes or Jaguar advertiser may pay more for a list of clients that reside in an affluent area). This verification may be performed by independent auditors that examine, test, and evaluate the demographic system (i.e., the computer software used to implement the Online Profile Management System 300 of FIG. 3) and the profile maintained by the ISP to determine. The independent auditors evaluate and test the software to determine if the method for obtaining and determining the information, and inserting a particular advertisement is reliable.

Thus, a method and apparatus for processing client information is described in conjunction with one or more specific embodiments. The invention is defined by the claims and their full scope of equivalents.

1. A method for processing client information using a computer system comprising:
a proxy obtaining client information relating to a client; and
customizing information transmitted, said customization based on said client information.

2. The method of claim 1 wherein said information is transmitted to at least one person other than said client.

3. The method of claim 1 wherein said information is transmitted to said client.

4. The method of claim 1 further comprising:
obtaining an IP address and port number;
mapping said IP address and port number to a unique user identifier; and
utilizing said unique user identifier to map said profile to a specific client.

5. The method of claim 1 wherein said client is comprised of a group of users.

6. The method of claim 1 wherein said client information comprises information regarding web pages displayed to said client.

7. The method of claim 1 wherein said client information comprises demographic information of said client.

8. The method of claim 1 wherein said client information comprises personal information of said client.

9. The method of claim 1 wherein said client information comprises network access of said client.

10. The method of claim 1 wherein said customized information is an advertisement.

11. The method of claim 1 wherein said customized information is email.

12. The method of claim 1 wherein said customized information is a web page.

13. The method of claim 1 wherein said customized information is comprised of a watermark.

14. The method of claim 1 wherein said customized information is customized by a web server.

15. The method of claim 1 wherein said customized information is customized by said proxy.

16. The method of claim 1 wherein said customized information is customized by a third party.

17. The method of claim 1 further comprising transmitting said client information to a web server.

18. A method for processing client information using a computer system comprising:
a proxy obtaining client information relating to a client; and
said proxy selling said client information to a third party.

19. The method of claim 18 where said third party is said client's internet service provider.

20. The method of claim 18 where said third party is an internet service provider said client is roaming with.

21. The method of claim 10 wherein:
said advertisement is obtained from said client's standard internet service provider; and
said advertisement is transmitted by an internet service provider said client is roaming with.

22. The method of claim 10 wherein a cost of said advertisement is negotiated by an internet service provider said client is roaming with.

23. A system comprising
a processor;
a memory coupled to said processor;
code executed by said processor configured to process client information;
said code comprising:
a method for a proxy obtaining client information relating to a client; and
a method customizing information transmitted, said customization based on said client information.

24. The system of claim 23 wherein said client information comprises information regarding web pages displayed to said client.

25. The system of claim 23 wherein said client information comprises demographic information of said client.

26. The system of claim 23 wherein said client information comprises personal information of said client.

27. The system of claim 23 wherein said client information comprises network access of said client.

28. The system of claim 23 wherein said customized information is an advertisement.

29. The system of claim 23 wherein said customized information is email.

30. The system of claim 23 wherein said customized information is a web page.

31. The system of claim 23 wherein said customized information is comprised of a watermark.

32. A system comprising
a processor;
a memory coupled to said processor;
code executed by said processor configured to process client information;
said code comprising:
a method for a proxy obtaining client information relating to a client; and
a method for said proxy selling said client information to a third party.

33. The system of claim 32 where said third party is said client's internet service provider.

34. The method of claim 32 where said third party is an internet service provider said client is roaming with.

35. The system of claim 28 wherein:
said advertisement is obtained from said client's standard internet service provider; and
said advertisement is transmitted by an internet service provider said client is roaming with.

36. The system of claim 28 wherein a cost of said advertisement is negotiated by an internet service provider said client is roaming with.

37. A computer program product comprising
a computer usable medium having computer readable program code embodied therein configured to process client information, said computer program product comprising:
computer readable code configured to cause a proxy to obtain profile information relating to a client; and
computer readable code configured to cause a computer to customize information transmitted, said customization based on said client information.

38. The computer program product of claim 37 wherein said client information comprises information regarding web pages displayed to said client.

39. The computer program product of claim 37 wherein said client information comprises demographic information of said client.

40. The computer program product of claim 37 wherein said client information comprises personal information of said client.

41. The computer program product of claim 37 wherein said client information comprises network access of said client.

42. The computer program product of claim 37 wherein said customized information is an advertisement.

43. The computer program product of claim 37 wherein said customized information is email.

44. The computer program product of claim 37 wherein said customized information is a web page.

45. The computer program product of claim 37 wherein said customized information is comprised of a watermark.

46. A computer program product comprising
a computer usable medium having computer readable program code embodied therein configured to process client information, said computer program product comprising:
computer readable code configured to cause a proxy to obtain client information relating to a client; and
computer readable code configured to cause a computer to customize information transmitted, said customization based on said client information.

47. The computer program product of claim 46 wherein said third party is said client's internet service provider.

48. The computer program product of claim 46 where said third party is an internet service provider said client is roaming with.

49. The computer program product of claim 42 wherein:
said advertisement is obtained from said client's standard internet service provider; and
said advertisement is transmitted by an internet service provider said client is roaming with.

50. The computer program product of claim 42 wherein a cost of said advertisement is negotiated by an internet service provider said client is roaming with.
